(19) United States
(12) Patent Application Publication
(10) Pub. No.: US 2020/0218584 A1
(43) Pub. Date: Jul. 9, 2020

(54) IDENTIFYING AND DEMARCATING APPLICATION TRANSACTIONS IN AN EVENT LOOP BASED RUNTIME

(71) Applicant: INTERNATIONAL BUSINESS MACHINES CORPORATION, Armonk, NY (US)

(72) Inventor: Gireesh Punathil, Kannur (IN)

(21) Appl. No.: 16/238,967

(22) Filed: Jan. 3, 2019

(51) Int. Cl. G06F 9/54

(52) U.S. Cl. CPC G06F 9/542

(57) ABSTRACT

Methods and systems for an event loop based runtime are disclosed. A method includes: receiving, by a computing device, a first request to register a first event in an event loop; in response to determining that the first request to register the first event is not triggered by a callback routine, the computing device generating an event list and storing an event descriptor for the first event in the event list; determining, by the computing device, that the first event has occurred; executing, by the computing device, a callback routine associated with the first event; marking, by the computing device, the first event as complete in the event list; determining, by the computing device, information about a transaction including a start time and an end time based on the event list; and outputting, by the computing device, the information about the transaction.

### BACKGROUND

The present invention generally relates to computing devices and, more particularly, to methods and systems for identifying and demarcating application transactions in an event loop based runtime.

An event loop based runtime typically places input/output (I/O) requests in an event loop of an event infrastructure when the requests are made by an application being executed. Other application code is typically executed inline by the event loop based runtime. The event loop based runtime typically polls the system for events in the event loop that have occurred, and for each event that has occurred, an associated routine that is registered with the event is sequentially executed. The execution of the associated routines may cause other events to be placed in the event loop of the event infrastructure. Once all of the events that have occurred are processed (by executing their associated routines), the event loop based runtime again polls the system for events, and the loop repeats.

### SUMMARY

In a first aspect of the invention, there is a method that includes: receiving, by a computing device, a first request to register a first event in an event loop; in response to determining that the first request to register the first event is not triggered by a callback routine, the computing device generating an event list and storing an event descriptor for the first event in the event list; determining, by the computing device, that the first event has occurred; executing, by the computing device, a callback routine associated with the first event; marking, by the computing device, the first event as complete in the event list; determining, by the computing device, information about a transaction including a start time and an end time based on the event list; and outputting, by the computing device, the information about the transaction.

In another aspect of the invention, there is a computer program product that includes a computer readable storage medium having program instructions embodied therewith. The program instructions are executable by a computing device to cause the computing device to: receive a first request to register a first event in an event loop; in response to determining that the first request to register the first event is not triggered by a callback routine, generate an event list and store an event descriptor for the first event in the event list; determine that the first event has occurred; execute a callback routine associated with the first event; mark the first event as complete in the event list; determine information about a transaction including a start time and an end time based on the event list; and output the information about the transaction.

In another aspect of the invention, there is a system that includes: a hardware processor, a computer readable memory, and a computer readable storage medium associated with a computing device; program instructions to receive a first request to register a first event in an event loop; program instructions to, in response to determining that the first request to register the first event is not triggered by a callback routine, generate an event list and store an event descriptor for the first event in the event list; program instructions to determine that the first event has occurred; program instructions to execute a callback routine associated with the first event; program instructions to mark the first event as complete in the event list; program instructions to determine information about a transaction including a start time and an end time based on the event list; and program instructions to output the information about the transaction, wherein the program instructions are stored on the computer readable storage medium for execution by the hardware processor via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a computer system in accordance with aspects of the invention.

FIG. 2 depicts an illustrative environment in accordance with aspects of the invention.

FIGS. 3 and 4 depict flowcharts of exemplary methods performed in accordance with aspects of the invention.

### DETAILED DESCRIPTION

The present invention generally relates to computing devices and, more particularly, to methods and systems for identifying and demarcating application transactions in an event loop based runtime. As described herein, aspects of the invention include a method and system for an event loop based runtime that generates an event list for each transaction in an application, each event list including information about events that are associated with a particular application transaction and that are registered in an event loop in connection with the particular application transaction. Aspects of the invention also include a method and system for an event loop based runtime that marks an event complete in an event list after execution of a callback routine registered in association with the event and that determines that an application transaction associated with a particular event list is complete when all of the events in the particular event list are marked as complete.

Accordingly, embodiments improve the functioning of a computer by providing methods and systems for an event loop based runtime that identifies and demarcates application transactions (e.g., by identifying code flow sequences that are units of user code execution and associating them into logical aggregations based on transactions and webserver workloads, without the user code actually designating them explicitly). In particular, embodiments improve software by providing an improved asynchronous, event-based, server side language runtime that generates an event list for each transaction in an application, each event list including information about events that are associated with a particular application transaction and that are registered in an event loop in connection with the particular application transaction. Embodiments also improve software by providing an improved asynchronous, event-based, server side language runtime that marks an event complete in an event list after execution of a callback routine registered in association with the event and that determines that an application transaction associated with a particular event list is complete when all of the events in the particular event list are marked as complete.

These software improvements provide an improved language runtime (e.g., virtual machine) that, by delineating transactions as well as transaction boundaries within a virtual machine, provides for monitoring transactions with precision, improved problem determination, improved request routing, improved circuit breaking, improved plans and policies for runtime internal accelerators such as garbage collection and just-in-time (JIT) compilation, and efficient usage of resources such as memory (for caching) and sockets (for networking). Furthermore, when the language runtime is hosted in a distributed computing environment (e.g., a cloud computing environment), the language runtime provides for metering microservices and application programming interfaces (APIs) with precision. In particular, the improved language runtime facilitates accurate measurements of the amount of time consumed by particular application transactions, enabling a service provider to more precisely compute service charges to a user based upon server time consumed in a distributed computing environment. Accordingly, through the use of rules that improve computer-related technology, implementations of the invention allow computer performance of functions not previously performable by a computer. Additionally, implementations of the invention use techniques that are, by definition, rooted in computer technology (e.g., virtual machines and language runtimes).

In embodiments, an asynchronous event loop based server side runtime identifies one or more code flow sequences in application code, without instrumenting or monkey-patching (i.e., modifying classes or methods at runtime and changing the behavior) the application code. Each of the code flow sequences identified by the runtime reflects one complete user transaction, and one transaction covers a single unit of a request-response pair in a client-server programming model.

In embodiments, when an event loop in the runtime is processing an event i out of a set of n events, every activity which the runtime performs until it picks up the (i+1)th event is a side effect of event i. These side effects may include: (i) performing central processing unit (CPU)-bound operations, (ii) performing I/O-bound operations, and/or (iii) initiating new-I/O bound operations, in which case the runtime adds new event descriptors back into the event loop. As the runtime will execute (i) and (ii) in-line in the same loop sequence before it yields to the next (i+1th) event, the runtime only tracks the new I/O-bound operations this event has instigated. All I/O-bound (including recursive) side effects pass through the event loop and therefore the runtime tracks these side effects as they are added to the event loop.

In embodiments, the runtime has a non-blocking event-driven architecture. Accordingly, an event infrastructure is used by the runtime's execution environment. In particular, every action that is pertinent to a transaction has a starting point originating from an event, which is an abstraction around I/O-readiness. The runtime first intercepts a transaction in the event infrastructure. At this point, the event infrastructure may not know a type or an extent of the transaction. However, the event infrastructure intercepts, records, and reports the beginning and end of a transaction based on identifying events outputting from the event infrastructure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

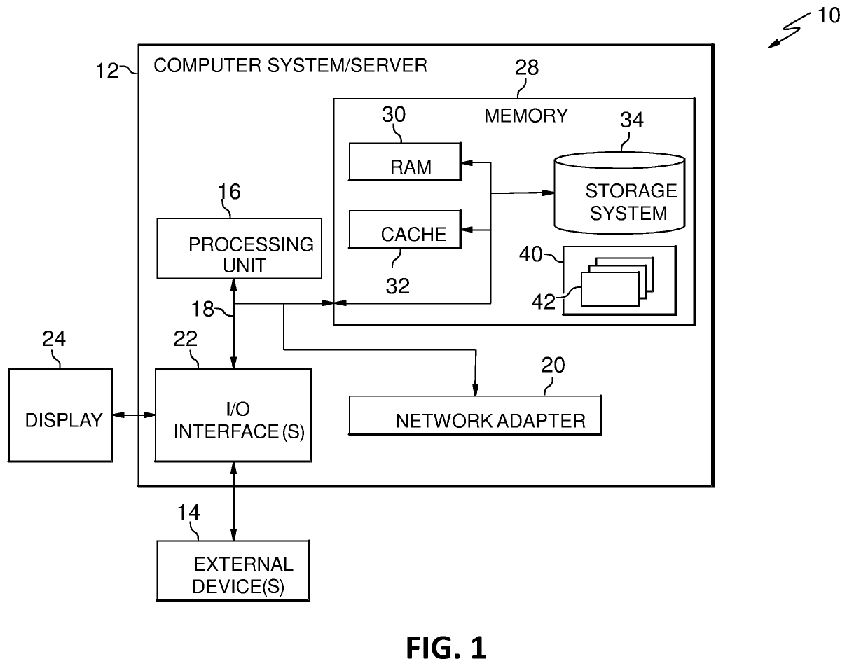

Referring now to FIG. 1, a schematic of an example of a computing infrastructure is shown. Computing infrastructure 10 is only one example of a suitable computing infrastructure and is not intended to suggest any limitation as to the scope of use or functionality of embodiments of the invention described herein. Regardless, computing infrastructure 10 is capable of being implemented and/or performing any of the functionality set forth hereinabove.

In computing infrastructure 10 there is a computer system (or server) 12, which is operational with numerous other general purpose or special purpose computing system environments or configurations. Examples of well-known computing systems, environments, and/or configurations that may be suitable for use with computer system 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system 12 may be described in the general context of computer system executable instructions, such as program modules, being executed by a computer system. Generally, program modules may include routines, programs, objects, components, logic, data structures, and so on that perform particular tasks or implement particular abstract data types. Computer system 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system 12 in computing infrastructure 10 is shown in the form of a general-purpose computing device. The components of computer system 12 may include, but are not limited to, one or more processors or processing units (e.g., CPU) 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system 12 typically includes a variety of computer system readable media. Such media may be any available media that is accessible by computer system 12, and it includes both volatile and non-volatile media, removable and non-removable media.

System memory 28 can include computer system readable media in the form of volatile memory, such as random access memory (RAM) 30 and/or cache memory 32. Computer system 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system 12 may also communicate with one or more external devices 14 such as a keyboard, a pointing device, a display 24, etc.; one or more devices that enable a user to interact with computer system 12; and/or any devices (e.g., network card, modem, etc.) that enable computer system 12 to communicate with one or more other computing devices. Such communication can occur via Input/Output (I/O) interfaces 22. Still yet, computer system 12 can communicate with one or more networks such as a local area network (LAN), a general wide area network (WAN), and/or a public network (e.g., the Internet) via network adapter 20. As depicted, network adapter 20 communicates with the other components of computer system 12 via bus 18. It should be understood that although not shown, other hardware and/or software components could be used in conjunction with computer system 12. Examples, include, but are not limited to: microcode, device drivers, redundant processing units, external disk drive arrays, RAID systems, tape drives, and data archival storage systems, etc.

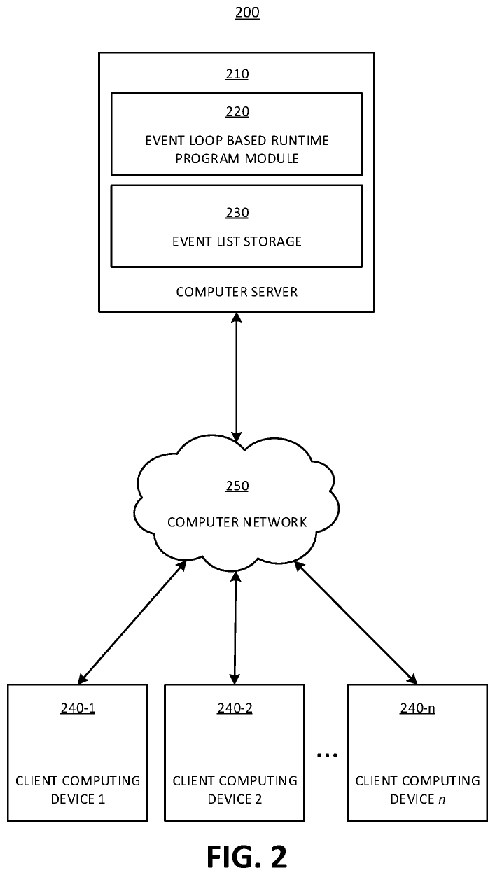

FIG. 2 depicts an illustrative environment 200 in accordance with aspects of the invention. As shown, the environment 200 comprises a computer server 210 and a plurality of client computing devices 240-1, 240-2, . . . , 240-n which are in communication via a computer network 250. In embodiments, the computer network 250 is any suitable network including any combination of a LAN, WAN, or the Internet. In embodiments, the computer server 210 and the client computing devices 240-1, 240-2, . . . , 240-n are physically collocated, or, more typically, are situated in separate physical locations.

The quantity of devices and/or networks in the environment 200 is not limited to what is shown in FIG. 2. In practice, the environment 200 may include additional devices and/or networks; fewer devices and/or networks; different devices and/or networks; or differently arranged devices and/or networks than illustrated in FIG. 2. Also, in some implementations, one or more of the devices of the environment 200 may perform one or more functions described as being performed by another one or more of the devices of the environment 200.

In embodiments, the computer server 210 is a computer device comprising one or more elements of the computer system/server 12 (as shown in FIG. 1). In particular, the computer server 210 is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients.

In embodiments, the computer server 210 includes an event loop based runtime program module 220, which includes hardware and/or software and is one or more of the program modules 42 shown in FIG. 1. The event loop based runtime program module 220 includes program instructions for an event loop based language runtime (virtual machine). In embodiments, the program instructions included in the event loop based runtime program module 220 of the computer server 210 are executed by one or more hardware processors.

In particular, in embodiments, the event loop based runtime program module 220 runs (implements) a single-threaded event-driven web program such as a microservice that receives requests from and provides responses to a plurality of clients, such as the client computing devices 240-1, 240-2, . . . , 240-n. In an example, a microservice running on the virtual machine program module 220 may have multiple pending client requests, including client requests that are being responded to, client requests that have been parsed but not yet responded to, and client requests under a listen backlog (e.g., waiting for a service listener to accept the connection).

In embodiments, programs running on the event loop based runtime program module 220 have well-defined lifecycle milestones for the transactions they carry. In particular, each transaction starts with a request from one of the client computing devices 240-1, 240-2, . . . , 240-n being intercepted in a listening socket. A client request callback in the program handles the received request. While the program may run arbitrary server code, every action pertinent to the transaction is either confined to this callback or emanates from this callback in the form of new events and event listeners. From the client request object, all artifacts (e.g., transaction objects, events, and their listeners) may be traced and reached. Finally, each transaction ends when the server response is closed.

Still referring to FIG. 2, in embodiments, the computer server 210 also includes an event list storage 230. According to an embodiment, the event list storage 230 is used by the event loop based runtime program module 220 to store a plurality of event lists. In embodiments, the event list storage 230 is implemented as hardware and/or software using components such as storage devices. In other embodiments, the event list storage 230 may be a storage device that is external to but accessible by the computer server 210.

Still referring to FIG. 2, in embodiments, each of the client computing devices 240-1, 240-2, . . . , 240-n is a computer device comprising one or more elements of the computer system/server 12 (as shown in FIG. 1). In embodiments, each of the client computing devices 240-1, 240-2, . . . , 240-n sends requests to and receives responses from a microservice running on the event loop based runtime program module 220 on the computer server 210. In particular, each of the client computing devices 240-1, 240-2, . . . , 240-n is implemented as hardware and/or software using components such as mainframes; RISC (Reduced Instruction Set Computer) architecture based servers; servers; blade servers; storage devices; networks and networking components; virtual servers; virtual storage; virtual networks, including virtual private networks; virtual applications and operating systems; and virtual clients. In other embodiments, each of the client computing devices 240-1, 240-2, . . . , 240-n is a desktop computer, a laptop computer, a mobile device such as a cellular phone, tablet, personal digital assistant (PDA), or other computing device.

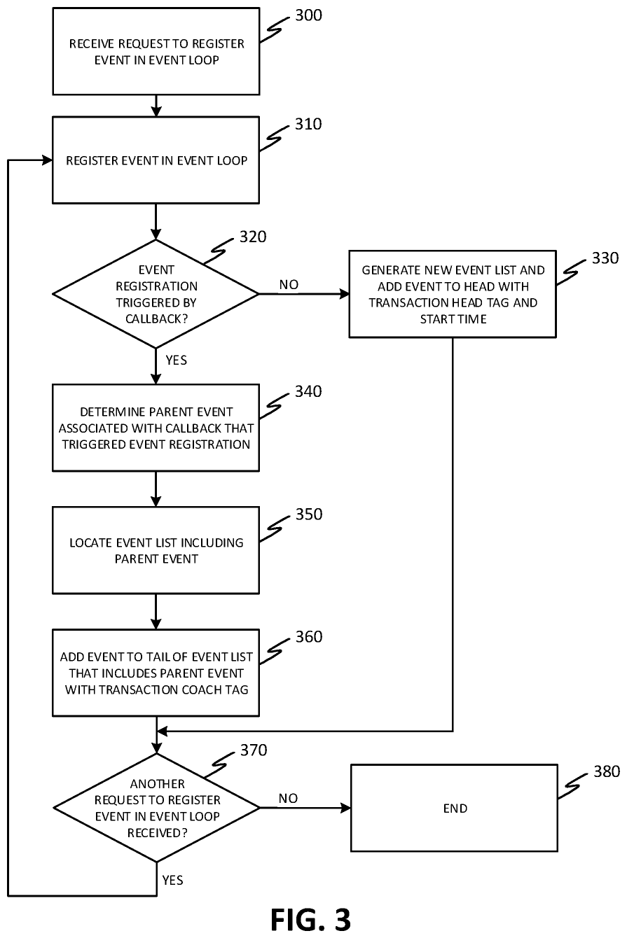

FIG. 3 depicts a flowchart of an exemplary method for adding events to events lists performed by the event loop based runtime program module 220 of the computer server 210 in accordance with aspects of the invention. The steps of the method are performed in the environment of FIG. 2 and are described with reference to the elements shown in FIG. 2.

At step 300, the computer server 210 receives a request to register an event in an event loop. In embodiments, during execution of application code by the event loop based runtime program module 220, a client request is received through an I/O call, which triggers the request to register the event in the event infrastructure.

At step 310, the computer server 210 registers the event in the event loop. In embodiments, the event loop based runtime program module 220, in response to receiving the request at step 300, registers the event in the event loop in the event infrastructure by binding a handler function (callback routine) with an event descriptor. The handler function (callback routine) contains code that is to be executed by the event loop based runtime program module 220 upon generation of the associated event.

At step 320, the computer server 210 determines whether or not the event registration was triggered by a callback. In embodiments, the event loop based runtime program module 220 determines whether or not the event registration at step 310 was triggered during execution of a callback routine associated with another event. In other words, the event loop based runtime program module 220 determines whether or not the associated event is a top level event (e.g., an event that is registered, polled and intercepted in the event loop based runtime program module 220 that has no predecessor) or a non-top level event (e.g., an event that is registered by an event handler routine which is associated with an existing event). In embodiments, top level events correspond to the start of a transaction.

Still referring to step 320, if the loop based runtime program module 220 determines that the event registration was not triggered during execution of a callback routine associated with another event (e.g., the event registration was triggered by a top level event such as a client request being received through an I/O call), then the flow proceeds to step 330. On the other hand, if the loop based runtime program module 220 determines that the event registration was triggered during execution of a callback routine associated with another event, then the flow proceeds to step 340.

At step 330, the computer server 210 generates a new event list and adds the event to the head with a transaction head tag and the start time. In embodiments, the event loop based runtime program module 220 generates a new event list, which is a linked list, and adds the event (e.g., as an event descriptor) to the head of the event list. The event loop based runtime program module 220 stores, with the event in the event list, a transaction head tag indicating that the event is a top level event (e.g., a client request) that starts a new transaction.

Still referring to step 330, the event loop based runtime program module 220 also stores, with the event in the event list, a time when the event was registered in the event loop at step 310 or a time when the event was added to the new event list at step 330. The flow then proceeds to step 370.

At step 340, the computer server 210 determines a parent event associated with the callback that triggered the event registration. In embodiments, the event loop based runtime program module 220 determines the parent event that triggered the callback routine that caused the registration of the event in the event loop at step 310.

At step 350, the computer server 210 locates the event list including the parent event. In embodiments, the event loop based runtime program module 220 locates the event list in the event list storage 330 in the computer server 310 that includes the parent event determined at step 340 by comparing an event descriptor of the parent event with the event descriptors stored in each of the event lists in the event list storage 330.

At step 360, the computer server 210 adds the event to the tail of the event list that includes the parent event with a transaction coach tag. In embodiments, the event loop based runtime program module 220 adds the event (e.g., as an event descriptor) to the tail of the event list located at step 350. The event loop based runtime program module 220 stores, with the event in the event list, the transaction coach tag indicating that the event is not a top level event (e.g., a client request) that starts a new transaction but rather is triggered by a callback routine associated with another event. The event loop based runtime program module 220 also optionally stores, with the event in the event list, a time when the event was registered in the event loop at step 310 or a time when the event was added to the event list at step 360.

At step 370, the computer server 210 determines whether or not another request to register an event in an event loop is received. In embodiments, the event loop based runtime program module 220 determines whether or not another request to register an event in the event loop is received, either based on a client request through an I/O call, which triggers another request to register an event in the event infrastructure, or based on a callback routine associated with another event in the application code. If the loop based runtime program module 220 determines that another request to register an event in the event loop is received, then the flow returns to step 310. On the other hand, if the loop based runtime program module 220 determines that another request to register an event in the event loop is not received, then the flow ends at step 380

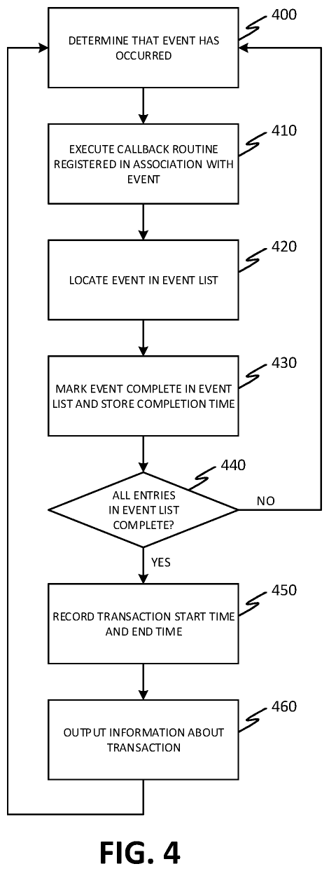

FIG. 4 depicts a flowchart of an exemplary method for an event infrastructure performed by the event loop based runtime program module 220 of the computer server 210 in accordance with aspects of the invention. The steps of the method are performed in the environment of FIG. 2 and are described with reference to the elements shown in FIG. 2.

At step 400, the computer server 210 determines that an event has occurred. In embodiments, the event loop based runtime program module 220 determines that the event has been generated (e.g., a client request is received through an I/O call).

At step 410, the computer server 210 executes a callback routine registered in association with the event. In embodiments, the event loop based runtime program module 220, in response to event manifestation, executes the callback routine that was registered, during event registration (e.g., at step 310 of FIG. 3), in association with the event determined to occur at step 400.

At step 420, the computer server 210 locates the event in the event list. In embodiments, the event loop based runtime program module 220 locates the event in one of the event lists stored in the event list storage 330 in the computer server 310 by comparing an event descriptor of the event determined to have occurred at step 400 with the event descriptors stored in each of the event lists in the event list storage 330.

At step 430, the computer server 210 marks the event complete in the event list and stores a completion time. In embodiments, the event loop based runtime program module 220 stores in the event list storage 330, with the event in the event list located at step 420, a tag indicating that the event is complete as well as a completion time when the callback routine executed at step 410 finished executing.

At step 440, the computer server 210 determines whether or not all of the events in the event list are complete. In embodiments, the event loop based runtime program module 220 scans each of the events in the event list containing the event that was marked complete at step 430 to determine whether or not all of the events in the event list are marked with a tag indicating that they are complete. If the loop based runtime program module 220 determines that not all of the events in the event list are complete, then the flow returns to step 400. On the other hand, if the loop based runtime program module 220 determines that all of the events in the event list are complete, then the flow proceeds to step 450.

At step 450, the computer server 210 records the transaction start time and the transaction end time. In embodiments, the event loop based runtime program module 220 records, as the transaction start time, the time when the event (with the tag transaction head) at the head of the event list was registered in the event loop at step 310 (of FIG. 3) or the time when the event at the head of the event list was added to the event list at step 330 (of FIG. 3). Additionally, the event loop based runtime program module 220 records, as the transaction end time, the completion time (stored at step 430) of the event in the event list that has the latest completion time.

At step 460, the computer server 210 outputs information about the transaction. In embodiments, the event loop based runtime program module 220 outputs, as the information about the transaction, a total time taken for the transaction, determined using the transaction start time and the transaction end time recorded at step 450. Additionally, in embodiments, the event loop based runtime program module 220 outputs information about gaps between transactions, based on start and end times recorded for other transactions at step 450.

Accordingly, it is understood from the foregoing description that embodiments of the invention provide a method to identify one or more code flow sequences in an asynchronous event loop based server side runtime software without instrumenting or monkey-patching the application code, wherein those code flow sequences reflect one complete user transaction, and one transaction covers a single unit of request-response pair in a client-server programming model.

Additionally, it is understood from the foregoing description that embodiments of the invention provide a method that includes receiving, by a computing device, a first request to register a first event in an event loop; in response to determining that the first request to register the first event is not triggered by a callback routine, the computing device generating an event list and storing an event descriptor for the first event in the event list; determining, by the computing device, that the first event has occurred; executing, by the computing device, a callback routine associated with the first event; determining all the events that are registered as part of the first event callback, and associating each of those under the event list of the first event; marking, by the computing device, the first event and all its associated events as complete in the event list; determining, by the computing device, information about a transaction including a start time and an end time based on the event list; and outputting, by the computing device, the information about the transaction.

In embodiments, a service provider could offer to perform the processes described herein. In this case, the service provider can create, maintain, deploy, support, etc., the computer infrastructure that performs the process steps of the invention for one or more customers. These customers may be, for example, any business that uses cloud computing technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
receiving, by a computing device, a first request to register a first event in an event loop;
in response to determining that the first request to register the first event is not triggered by a callback routine, the computing device generating an event list and storing an event descriptor for the first event in the event list;
determining, by the computing device, that the first event has occurred;
executing, by the computing device, a callback routine associated with the first event;
marking, by the computing device, the first event as complete in the event list;
determining, by the computing device, information about a transaction including a start time and an end time based on the event list;
outputting, by the computing device, the information about the transaction;
receiving, by the computing device, a second request to register a second event in the event loop; and
in response to determining that the second request to register the second event is triggered by the callback routine, the computing device determining that the first event is a parent event for the second event and storing an event descriptor for the second event in the event list including the first event.

2. (canceled)

3. The method according to claim 1, further comprising adding the event descriptor for the first event to a head of the event list.

4. The method according to claim 3, further comprising adding the event descriptor for the second event to a tail of the event list.

5. The method according to claim 1, further comprising determining, by the computing device, that each of a plurality of events in the event list is complete,
wherein the determining the information about the transaction is performed in response to the determining that each of the plurality of events in the event list is complete.

6. The method according to claim 5, further comprising determining the start time based on a time when the first event was added to the event list.

7. The method according to claim 6, further comprising determining the end time based on a time when the second event was marked as complete.

8. A computer program product comprising a computer readable storage medium having program instructions embodied therewith, the program instructions executable by a computing device to cause the computing device to:
receive a first request to register a first event in an event loop;
in response to determining that the first request to register the first event is not triggered by a callback routine, generate an event list and store an event descriptor for the first event in the event list;
determine that the first event has occurred;
execute a callback routine associated with the first event;
mark the first event as complete in the event list;
determine information about a transaction including a start time and an end time based on the event list;
output the information about the transaction;
receive a second request to register a second event in the event loop; and
in response to determining that the second request to register the second event is triggered by the callback routine, determine that the first event is a parent event for the second event and store an event descriptor for the second event in the event list including the first event.

9. (canceled)

10. The computer program product according to claim 8, wherein the event descriptor for the first event is added to a head of the event list.

11. The computer program product according to claim 10, wherein the event descriptor for the second event is added to a tail of the event list.

12. The computer program product according to claim 8, the program instructions further being executable by the computing device to cause the computing device to determine that each of a plurality of events in the event list is complete,
wherein the determining the information about the transaction is performed in response to the determining that each of the plurality of events in the event list is complete.

13. The computer program product according to claim 12, wherein the start time is determined based on a time when the first event was added to the event list.

14. The computer program product according to claim 13, wherein the end time is determined based on a time when the second event was marked as complete.

15. A system comprising:
a hardware processor, a computer readable memory, and a computer readable storage medium associated with a computing device;
program instructions to receive a first request to register a first event in an event loop;
program instructions to, in response to determining that the first request to register the first event is not triggered by a callback routine, generate an event list and store an event descriptor for the first event in the event list;
program instructions to determine that the first event has occurred;
program instructions to execute a callback routine associated with the first event;
program instructions to mark the first event as complete in the event list;
program instructions to determine information about a transaction including a start time and an end time based on the event list;
program instructions to output the information about the transaction;
program instructions to receive a second request to register a second event in the event loop; and
program instructions to, in response to determining that the second request to register the second event is triggered by the callback routine, determine that the first event is a parent event for the second event and store an event descriptor for the second event in the event list including the first event,
wherein the program instructions are stored on the computer readable storage medium for execution by the hardware processor via the computer readable memory.

16. (canceled)

17. The system according to claim 15, wherein the event descriptor for the first event is added to a head of the event list.

18. The system according to claim 17, wherein the event descriptor for the second event is added to a tail of the event list.

19. The system according to claim 15, further comprising program instructions to determine that each of a plurality of events in the event list is complete,
wherein the determining the information about the transaction is performed in response to the determining that each of the plurality of events in the event list is complete.

20. The system according to claim 19, wherein the start time is determined based on a time when the first event was added to the event list and the end time is determined based on a time when the second event was marked as complete.
